(19) United States
(12) Patent Application Publication
(10) Pub. No.: US 2025/0379459 A1
(43) Pub. Date: Dec. 11, 2025

(54) BATTERY PROTECTION CIRCUIT FOR USE WITH BIDIRECTIONAL POWER CONVERTER

(71) Applicant: MILWAUKEE ELECTRIC TOOL CORPORATION, Brookfield, WI (US)

(72) Inventor: Benjamin C. Tesch, Milwaukee, WI (US)

(21) Appl. No.: 19/218,975

(22) Filed: May 27, 2025

Related U.S. Application Data
(60) Provisional application No. 63/656,740, filed on Jun. 6, 2024.

(51) Int. Cl. H02J 7/00

(52) U.S. Cl. CPC H02J 7/00304; H02J 7/0013; H02J 7/0047; H02J 2207/20

(57) ABSTRACT

A battery is electrically coupled to a bidirectional power converter (i) to output discharge current through a first electrical path between battery cells and the bidirectional power converter, and (ii) to receive charging current through the first electrical path from the bidirectional power converter. A battery management system is configured to monitor the battery cells, detect a fault condition of the battery cells, transmit a first control signal to the bidirectional power converter to control the bidirectional power converter to cease operating in response to detecting the fault condition of the one or more battery cells, and transmit a second control signal to a switching element to close the switching element to cause a short circuit between a positive side and a negative side of the battery to cause a first overcurrent protection device to open to prevent current from flowing into or out of the battery cells.

### RELATED APPLICATIONS

This application claims priority to U.S. Provisional Patent Application No. 63/656,740, filed on Jun. 6, 2024, the entire contents of which are hereby incorporated by reference.

### FIELD

Some disclosed embodiments relate to a battery protection circuit for a battery that is electrically coupled to a bidirectional power converter.

### SUMMARY

Electronic/electrical devices (such as a power tool, a power tool battery pack, a portable power source, and/or the like) may include one or more power converters to convert alternating current (AC) to direct current (DC) or vice versa. For example, a portable power source may include a power converter to convert AC current from an AC power source to DC current to charge a battery included in the portable power source. Continuing this example, the portable power source may also include a power converter to convert DC current from the battery to an AC load to provide power to the AC load. Traditionally, the charging and discharging functions of a battery (such as a power tool battery pack, the battery included in the portable power source explained above, etc.) are performed by separate power converters with different power transfer capabilities. Due to the use of two different power converters with different power transfer capabilities, batteries typically have separate/distinct charging and discharging electrical paths such that separate/distinct charging and discharging protection circuits can be used to protect battery cells (e.g., prevent current flow) in the event of a fault condition (e.g., overcurrent, etc.).

Higher power is typically transferred when a battery is discharging current for most applications than when the battery is being charged (i.e., receiving charging current). The use of separate/distinct electrical paths for charging and discharging relaxes the requirements on protective devices in the charging path since lower power is typically transferred in the charging path than in the discharging path. Accordingly, a fuse in the charging path may be configured to open to prevent current flow at a lower current than the charge current rating of the battery, providing a high degree of passive protection against overcurrent during charging. A separate fuse in the discharging path may be configured to open to prevent current flow at a higher current than the charging path fuse since the discharging current is often expected and desired to be higher than the charging current.

However, when a battery is used with a bidirectional power converter that can transfer the same or a similar high power/current level in both directions (i.e., discharging current from the battery and charging current to the battery) via the same electrical path, there is only a single electrical path where protective devices/circuits may be placed. Therefore, any protective circuitry in the single electrical path should be configured to both pass the full discharge current during normal operation, interrupt a full discharge fault current when a fault condition is present, and prevent battery cells from receiving charging current in response to a lesser fault condition (e.g., an overcurrent that is lower than the full discharge fault current) being detected during charging.

While such protective circuitry is useful in situations where a battery is used with the bidirectional power converter that provides current flow in both directions (e.g., a portable power source), such protective circuitry may also be used when the bidirectional power converter is only used to provide current flow in a single direction (e.g., in a power tool to provide DC current from an attached battery pack that is charged using a separate charging device). In other words, the bidirectional power converter may be used in many different situations/applications/devices and may provide current flow in a first direction, current flow in a second direction opposite to the first direction, and/or current flow in both directions at different times. Regardless of whether the bidirectional power converter is used to provide current flow in both directions for a given situation/application/device, its ability to do so via a single electrical path makes it useful for batteries used with the bidirectional power converter to include a battery protection circuit configured to both pass the full discharge current during normal operation, interrupt a full discharge fault current when a fault condition is present, and prevent battery cells from receiving charging current in response to a lesser fault condition (e.g., an overcurrent that is lower than the full discharge fault current) being detected during charging.

One embodiment provides a battery that may include one or more battery cells electrically coupled to a bidirectional power converter via a positive terminal and a negative terminal. The one or more battery cells may be configured to output discharge current through a first electrical path between the one or more battery cells and the bidirectional power converter. The first electrical path may include (i) a positive electrical path between the one or more battery cells and the positive terminal and (ii) a negative electrical path between the one or more battery cells and the negative terminal. The one or more battery cells may also be configured to receive charging current through the first electrical path from the bidirectional power converter. The battery may also include a first overcurrent protection device, and a second overcurrent protection device electrically coupled in series with the first overcurrent protection device. A series combination of the first overcurrent protection device and the second overcurrent protection device may be electrically coupled between the one or more battery cells and the bidirectional power converter in one of the positive electrical path and the negative electrical path. The battery may also include a switching element that may include a first terminal electrically coupled between a junction between the first overcurrent protection device and the second overcurrent protection device. The switching element may also include a second terminal electrically coupled to the other one of the positive electrical path and the negative electrical path. The battery may also include a battery management system communicatively coupled to the switching element. The battery management system may be configured to monitor the one or more battery cells, and detect a fault condition of the one or more battery cells. The battery management system may also be configured to transmit a first control signal to the bidirectional power converter to control the bidirectional power converter to cease operating in response to detecting the fault condition of the one or more battery cells. The battery management system may also be configured to transmit a second control signal to the switching element to close the switching element to cause a short circuit between the positive electrical path and the negative electrical path. The short circuit between the positive electrical path and the negative electrical path may cause at least the first overcurrent protection device to open to prevent current from flowing into or out of the one or more battery cells.

In addition to any combination of features described above, the first overcurrent protection device may be electrically coupled between the one or more battery cells and the second overcurrent protection device. The second overcurrent protection device may be electrically coupled between the first overcurrent protection device and the bidirectional power converter. The short circuit between the positive electrical path and the negative electrical path may cause the second overcurrent protection device to open in response to current from the bidirectional power converter through the short circuit exceeding a current limit of the second overcurrent protection device. Opening of the second overcurrent protection device may prevent current draw from the bidirectional power converter.

In addition to any combination of features described above, the first overcurrent protection device may be electrically coupled between the one or more battery cells and the second overcurrent protection device. The second overcurrent protection device may be electrically coupled between the first overcurrent protection device and the bidirectional power converter. The first overcurrent protection device may open in response to current from the one or more battery cells through the short circuit exceeding a current limit of the first overcurrent protection device.

In addition to any combination of features described above, the battery management system may be configured to wait a predetermined time period after transmitting the first control signal to the bidirectional power converter, determine that the bidirectional power converter has not ceased operating within the predetermined time period, and transmit the second control signal to the switching element to close the switching element to cause the short circuit between the positive electrical path and the negative electrical path in response to determining that the bidirectional power converter has not ceased operating.

In addition to any combination of features described above, the battery management system may be configured to determine, before the predetermined time period has elapsed, that (i) the fault condition has worsened, (ii) a second fault condition has been detected, or (iii) both (i) and (ii). The battery management system may also be configured to transmit, before the predetermined time period has elapsed, the second control signal to the switching element to close the switching element to cause the short circuit between the positive electrical path and the negative electrical path in response to determining that (i) the fault condition has worsened, (ii) the second fault condition has been detected, or (iii) both (i) and (ii).

In addition to any combination of features described above, the battery management system may be configured to wait a predetermined time period after transmitting the first control signal to the bidirectional power converter, determine that the bidirectional power converter has ceased operating within the predetermined time period, and refrain from transmitting the second control signal to the switching element to close the switching element to cause the short circuit between the positive electrical path and the negative electrical path in response to determining that the bidirectional power converter has ceased operating.

Another embodiment provides a battery that may include one or more battery cells electrically coupled to a bidirectional power converter. The one or more battery cells may be configured to output discharge current through a first electrical path between the one or more battery cells and the bidirectional power converter. The one or more battery cells also may be configured to receive charging current through the first electrical path from the bidirectional power converter. The battery may also include a first overcurrent protection device electrically coupled between the one or more battery cells and the bidirectional power converter. The first overcurrent protection device may be electrically coupled to one of a positive side and a negative side of the battery. The battery may also include a switching element that may include a first terminal electrically coupled between a junction between the first overcurrent protection device and the bidirectional power converter. The switching element also may include a second terminal electrically coupled to the other one of the positive side and the negative side of the battery. The battery may also include a battery management system communicatively coupled to the switching element. The battery management system may be configured to monitor the one or more battery cells, and detect a fault condition of the one or more battery cells. The battery management system may also be configured to transmit a first control signal to the bidirectional power converter to control the bidirectional power converter to cease operating in response to detecting the fault condition of the one or more battery cells. The battery management system may also be configured to transmit a second control signal to the switching element to close the switching element to cause a short circuit between the positive side and the negative side of the battery. The short circuit between the positive side and the negative side may cause the first overcurrent protection device to open to prevent current from flowing into or out of the one or more battery cells.

In addition to any combination of features described above, the battery may include a second overcurrent protection device electrically coupled in series with the first overcurrent protection device. A series combination of the first overcurrent protection device and the second overcurrent protection device may be electrically coupled between the one or more battery cells and the bidirectional power converter on the one of the positive side and the negative side of the battery. The first overcurrent protection device may be electrically coupled between the one or more battery cells and the second overcurrent protection device, and the second overcurrent protection device may be electrically coupled between the first overcurrent protection device and the bidirectional power converter. The junction may be located between the first overcurrent protection device and the second overcurrent protection device. The short circuit between the positive side and the negative side may cause the second overcurrent protection device to open in response to current from the bidirectional power converter through the short circuit exceeding a second current limit of the second overcurrent protection device. Opening of the second overcurrent protection device may prevent current draw from the bidirectional power converter. The first overcurrent protection device may open in response to current from the one or more battery cells through the short circuit exceeding a first current limit of the first overcurrent protection device.

In addition to any combination of features described above, the battery management system may be configured to wait a predetermined time period after transmitting the first control signal to the bidirectional power converter, determine that the bidirectional power converter has not ceased operating within the predetermined time period, and transmit the second control signal to the switching element to close the switching element to cause the short circuit between the positive side and the negative side in response to determining that the bidirectional power converter has not ceased operating.

In addition to any combination of features described above, the battery management system may be configured to determine, before the predetermined time period has elapsed, that (i) the fault condition has worsened, (ii) a second fault condition has been detected, or (iii) both (i) and (ii). Th battery management system may also be configured to transmit, before the predetermined time period has elapsed, the second control signal to the switching element to close the switching element to cause the short circuit between the positive side and the negative side in response to determining that (i) the fault condition has worsened, (ii) the second fault condition has been detected, or (iii) both (i) and (ii).

In addition to any combination of features described above, the battery management system may be configured to determine that the bidirectional power converter has ceased operating, and refrain from transmitting the second control signal to the switching element to close the switching element to cause the short circuit between the positive side and the negative side in response to determining that the bidirectional power converter has ceased operating.

In addition to any combination of features described above, the battery may include a plurality of sensors configured to monitor the one or more battery cells. The plurality of sensors may be communicatively coupled to the battery management system. The plurality of sensors may include at least one of a group consisting of: a current sensor configured to monitor the discharge current and the charging current; a temperature sensor configured to monitor at least one of a group consisting of a temperature of individual battery cells of the one or more battery cells, a temperature of the battery, an ambient temperature of an environment in which the battery is located, and combinations thereof; a voltage sensor configured to monitor a voltage of individual battery cells of the one or more battery cells, an overall voltage of the one or more battery cells, or both the voltage of individual battery cells of the one or more battery cells and the overall voltage of the one or more battery cells; and combinations thereof.

In addition to any combination of features described above, the first overcurrent protection device may include one of a fuse, a positive temperature coefficient (PTC) element, a circuit breaker, and a burn track. The switching element may include one of a thyristor, a transistor, a relay, a contactor, and a thyratron.

In addition to any combination of features described above, the battery may include a housing configured to house the one or more battery cells, the first overcurrent protection device, the switching element, and the battery management system. The housing may include at least one of a group consisting of (i) a removable battery pack housing configured to be removably coupled to a power tool device, (ii) a portable power source housing, (iii) a power tool device housing, and (iv) combinations thereof.

Another embodiment provides a method of controlling a battery. The method may include outputting, by one or more battery cells of the battery in a discharging state, discharge current through a first electrical path between the one or more battery cells and a bidirectional power converter. The method may also include receiving, by the one or more battery cells in a charging state, charging current through the first electrical path. The method may also include monitoring, with a battery management system of the battery, the one or more battery cells of the battery while the one or more battery cells are in the discharging state and while the one or more battery cells are in the charging state. The method may also include detecting, with the battery management system, a fault condition of the one or more battery cells. The method may also include transmitting, with the battery management system, a first control signal to the bidirectional power converter to control the bidirectional power converter to cease operating in response to detecting the fault condition of the one or more battery cells. The method may also include transmitting, with the battery management system, a second control signal to a switching element to close the switching element to cause a short circuit between a positive side and a negative side of the battery. The short circuit between the positive side and the negative side may cause a first overcurrent protection device to open to prevent current from flowing into or out of the one or more battery cells.

In addition to any combination of features described above, the short circuit between the positive side and the negative side may cause a second overcurrent protection device to open to prevent current draw from the bidirectional power converter. The second overcurrent protection device may be electrically coupled in series with the first overcurrent protection device. A series combination of the first overcurrent protection device and the second overcurrent protection device may be electrically coupled between the one or more battery cells and the bidirectional power converter on one of the positive side and the negative side of the battery. The first overcurrent protection device may be electrically coupled between the one or more battery cells and the second overcurrent protection device, and the second overcurrent protection device may be electrically coupled between the first overcurrent protection device and the bidirectional power converter. The short circuit between the positive side and the negative side may cause the second overcurrent protection device to open in response to current from the bidirectional power converter through the short circuit exceeding a second current limit of the second overcurrent protection device. The first overcurrent protection device may open in response to current from the one or more battery cells through the short circuit exceeding a first current limit of the first overcurrent protection device.

In addition to any combination of features described above, the method may include waiting, with the battery management system, a predetermined time period after transmitting the first control signal to the bidirectional power converter. The method may also include determining, with the battery management system, that the bidirectional power converter has not ceased operating within the predetermined time period. The method may also include transmitting, with the battery management system, the second control signal to the switching element to close the switching element to cause the short circuit between the positive side and the negative side in response to determining that the bidirectional power converter has not ceased operating.

In addition to any combination of features described above, the method may include determining, with the battery management system and before the predetermined time period has elapsed, that (i) the fault condition has worsened, (ii) a second fault condition has been detected, or (iii) both (i) and (ii). The method may also include transmitting, with the battery management system and before the predetermined time period has elapsed, the second control signal to the switching element to close the switching element to cause the short circuit between the positive side and the negative side in response to determining that (i) the fault condition has worsened, (ii) the second fault condition has been detected, or (iii) both (i) and (ii).

In addition to any combination of features described above, the method may include determining, with the battery management system, that the bidirectional power converter has ceased operating, and refraining, with the battery management system, from transmitting the second control signal to the switching element to close the switching element to cause the short circuit between the positive side and the negative side in response to determining that the bidirectional power converter has ceased operating.

In addition to any combination of features described above, monitoring the one or more battery cells may include monitoring, with a plurality of sensors, the one or more battery cells. The plurality of sensors may be communicatively coupled to the battery management system. The plurality of sensors may include at least one of a group consisting of: a current sensor configured to monitor the discharge current and the charging current; a temperature sensor configured to monitor at least one of a group consisting of a temperature of individual battery cells of the one or more battery cells, a temperature of the battery, an ambient temperature of an environment in which the battery is located, and combinations thereof; a voltage sensor configured to monitor a voltage of individual battery cells of the one or more battery cells, an overall voltage of the one or more battery cells, or both the voltage of individual battery cells of the one or more battery cells and the overall voltage of the one or more battery cells; and combinations thereof.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 is a simplified block diagram of an electronic/electrical device including a battery and a bidirectional power converter in accordance with some example embodiments.

FIG. 2A-2C are perspective views of different electronic devices including the battery and the bidirectional power converter of FIG. 1 in accordance with some example embodiments.

FIG. 3 is a simplified block diagram of an inverter bridge of the bidirectional power converter of FIG. 1 in accordance with some example embodiments.

FIG. 4 illustrates a schematic circuit diagram of the battery of FIG. 1 coupled to the bidirectional power converter of FIG. 1 according to some example embodiments.

FIG. 5 illustrates a flowchart of a method executable by a battery management system of the battery of FIG. 4 to provide fault protection to the battery in response to a fault condition being detected according to some example embodiments.

### DETAILED DESCRIPTION

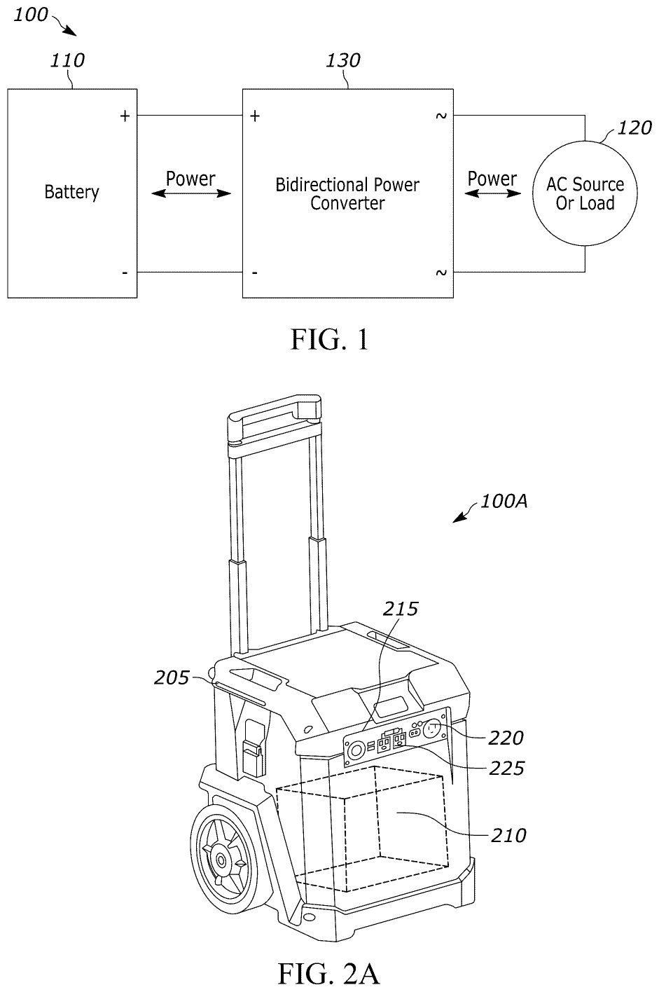

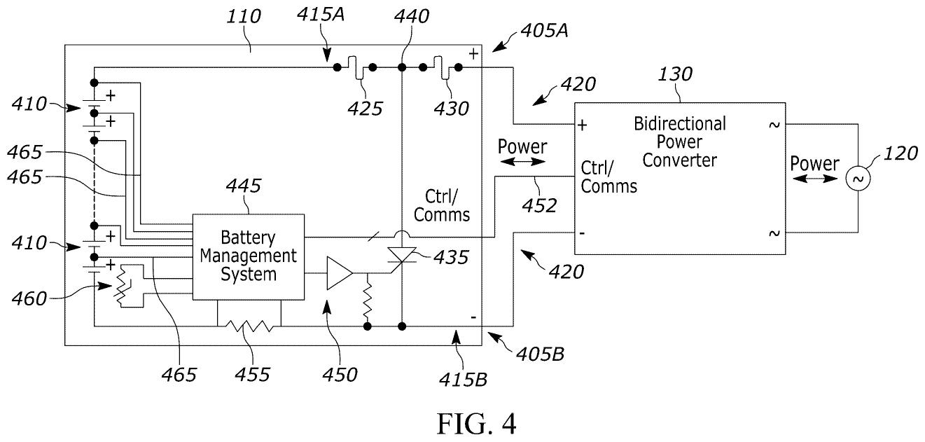

FIG. 1 illustrates a simplified block diagram of an example electronic (i.e., electrical) device 100. The electronic device 100 includes a battery system 110 (i.e., battery 110), an alternating current (AC) source or load 120, and a bidirectional power converter 130 electrically connected between the battery system 110 and the AC source or load 120. The bidirectional power converter 130 is configured to convert direct current (DC) to AC and is also configured to convert AC to DC. For example, the bidirectional power converter 130 converts DC power from the battery system 110 to AC power for the load 120 and converts AC power from the AC source 120 to DC power to charge the battery system 110. In some instances, the bidirectional power converter 130 may be used in an electronic device 100 (e.g., some instances of a power tool 100C as explained herein) such that current is only converted in one direction (e.g., from the battery system 110 to the load 120) even though the bidirectional power converter 130 may be capable of converting current in the opposite direction. In some instances, the bidirectional power converter 130 is configured to transfer the same or a similar high power/current level in both directions (i.e., discharging current from the battery system 110 and charging current to the battery system 110) via the same electrical path 420 (see FIG. 4) at different times rather than including a discharging electrical path that is separate/distinct from a charging electrical path as explained previously herein. The bidirectional power converter 130 may be referred to as a symmetric bidirectional power converter 130 and/or as a bidirectional power converter 130 with symmetric power transfer capability.

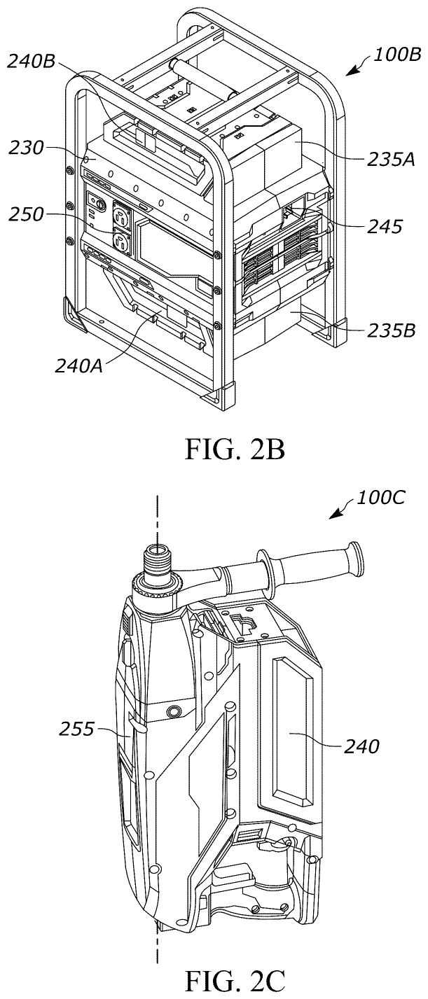

FIG. 2A illustrates an example electronic device 100 in the form of a portable power source/supply 100A. The portable power source 100A includes a housing 205 for housing an internal battery system 210. The housing 205 also includes an input/output panel 215. The input/output panel 215 includes a power input 220 and a power outlet 225. The power outlet 225 is for example, an AC outlet for powering AC electronic devices. The internal battery system 210 corresponds to the battery system 110. In some instances, the internal battery system includes an integrated battery core that is not configured to be removable from the housing 205 by a user. The power input 220 and the power outlet 225 correspond to the AC source 120 or AC load 120, respectively. The bidirectional power converter 130 is coupled between the internal battery system 210, the power input 220, and the power outlet 225. The bidirectional power converter 130 converts DC power from the internal battery system 210 to AC power for the power outlet 225. The bidirectional power converter 130 also converts the AC power from the power input 220 to DC power for charging the internal battery system 210. As indicated previously herein, (i) the DC power provided by the internal battery system 210 to the bidirectional power converter 130 to be converted to AC power and (ii) the DC power provided by the bidirectional power converter 130 to the internal battery system 210 for charging the internal battery system 210 both travel on the same electrical path 420 (see FIG. 4) but at different times. The portable power source 100A may include additional components other than those described and illustrated herein. For example, the portable power source 100A may include additional power outlets 225 (e.g., both AC and DC), a display, and the like.

FIG. 2B illustrates an example electronic device 100 in the form of another portable power source/supply 100B. The portable power source 100B includes a housing 230 having a first battery interface 235A and a second battery interface 235B. The first battery interface 235A and the second battery interface 235B are configured to respectively receive a first removable power tool battery pack 240A and a second removable power tool battery pack 240B respectively. The first removable power tool battery pack 240A and the second removable power tool battery pack 240B, referred to singularly as a removable power tool battery pack 240, are for example, lithium-ion power tool battery packs having a nominal voltage of 12 Volts, 18 Volts, 24 Volts, 36 Volts, 54 Volts, 72 Volts, 90 Volts, 108 Volts, or the like. The removable power tool battery pack 240 may be used to power cordless indoor and outdoor power tools. The portable power source 100B also includes a power input 245 and a power outlet 250. The power outlet 250 is for example, an AC outlet for power AC electronic devices. The removable power tool battery packs 240 correspond to the battery system 110. The power input 245 and the power outlet 250 correspond to the AC source 120 or AC load 120, respectively. The bidirectional power converter 130 is coupled between the removable power tool battery packs 240, the power input 245, and the power outlet 250. The bidirectional power converter 130 converts DC power from the removable power tool battery packs 240 to AC power for the power outlet 250. The bidirectional power converter 130 also converts the AC power from the power input 245 to DC power for charging the removable power tool battery packs 240. As indicated previously herein, (i) the DC power provided by the power tool battery packs 240 to the bidirectional power converter 130 to be converted to AC power and (ii) the DC power provided by the bidirectional power converter 130 to the power tool battery packs 240 for charging the power tool battery packs 240 both travel on the same electrical path 420 (see FIG. 4) but at different times. The portable power source 100B may include additional components other than those described and illustrated herein. For example, the portable power source 100B may include additional power outlets 250 (e.g., both AC and DC), a display, and the like.

FIG. 2C illustrates an example electronic device 100 in the form of a power tool 100C. In the example illustrated, the power tool 100C is a handheld core drill. The power tool 100C may include a different type of indoor and outdoor, handheld or mounted, power tool, for example, drill/drivers, saws, hammer drills, lighting equipment, grinders, or the like. The power tool 100C includes a housing 255 that houses a motor and that receives a removable power tool battery pack 240. The removable power tool battery pack 240 corresponds to the battery system 110 and the motor corresponds to the AC load 120. The bidirectional power converter 130 is coupled between the removable power tool battery pack 240 and the motor. The bidirectional power converter 130 converts DC power from the removable power tool battery pack 240 to AC power for the motor. In some examples, the power tool 100C may further include a power cord to receive AC power. In these examples, the bidirectional power converter 130 also converts the AC power from the power input or from the motor to DC power for charging the removable power tool battery pack 240. As indicated previously herein, (i) the DC power provided by the power tool battery pack 240 to the bidirectional power converter 130 to be converted to AC power and (ii) the DC power provided by the bidirectional power converter 130 to the power tool battery pack 240 for charging the power tool battery pack 240 both travel on the same electrical path 420 (see FIG. 4) but at different times. The power tool 100C may include additional components other than those described and illustrated herein.

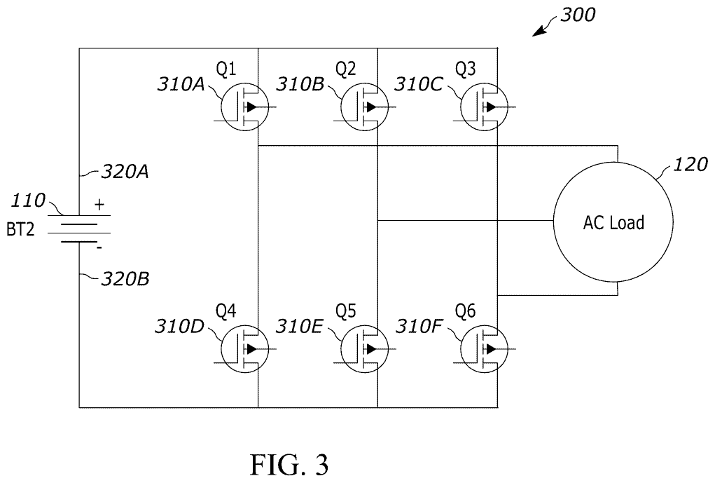

FIG. 3 illustrates a simplified block diagram of an inverter 300 that may be included in the bidirectional power converter 130. In the example illustrated, the inverter 300 includes six switches provided in an inverter bridge configuration. The switches include three high-side switches 310A, 310B, 310C electrically connected between a positive terminal 320A of the battery system 110 and the AC source or load 120. The switches also include three low-side switches 310D, 310E, 310F electrically connected between a negative terminal 320B of the battery system 110 and the AC source or load 120. The plurality of switches 310A-F are controlled by a controller using a gate driver to convert DC power from the battery system 110 to AC power for the AC load 120.

In one example, the plurality of switches 310A-F include metal oxide semiconductor field effect transistors (MOSFETs). In another example, the plurality of switches 310A-F include wide bandgap semiconductor FETs, that is Gallium Nitride (GaN) and/or Silicon Carbide (SiC) based FETs. In yet another example, the plurality of switches 310A-F may include a combination of MOSFETs and wide bandgap semiconductor FETs.

As explained previously herein, when the battery 110 is used with the bidirectional power converter 130 that can transfer the same or a similar high power/current level in both directions (i.e., discharging current from the battery 110 and charging current to the battery 110) via the same electrical path at different times, there is only a single electrical path where protective devices/circuits may be placed. Therefore, any protective circuitry in the single electrical path should be configured to both pass the full discharge current during normal operation, interrupt a full discharge fault current when a fault condition is present, and prevent battery cells from receiving charging current in response to a lesser fault condition (e.g., an overcurrent that is lower than the full discharge fault current) being detected during charging.

FIG. 4 illustrates a schematic circuit diagram of the battery 110 coupled to the bidirectional power converter 130 according to some example embodiments. As shown in FIG. 4, the bidirectional power converter 130 is coupled between the AC source or load 120 and the battery 110 as explained previously herein. The battery 110 includes a positive terminal 405A and a negative terminal 405B that are electrically coupled to the bidirectional power converter 130. The positive terminal 405A is electrically coupled to a positive end of one or more battery cells 410. The negative terminal 405B is electrically coupled to a negative end of the one or more battery cells 410. An electrical path between a positive end of the one or more battery cells 410 and the positive terminal 405A may be referred to as a positive electrical path 415A or a positive side 415A of the battery 110. An electrical path between a negative end of the one or more battery cells 410 and the negative terminal 405B may be referred to as a negative electrical path 415B or a negative side 415B of the battery 110.

A first electrical path 420 between the one or more battery cells 410 and the bidirectional power converter 130 includes the positive electrical path 415A and the negative electrical path 415B. As explained previously herein, in some instances, the first electrical path 420 may be the lone electrical path through which discharging current and charging current flow at different times. In other words, (i) the DC power provided by the one or more battery cells 410 to the bidirectional power converter 130 to be converted to AC power and (ii) the DC power provided by the bidirectional power converter 130 to the one or more battery cells 410 for charging the one or more battery cells 410 both travel on the same first electrical path 420 but at different times. The one or more battery cells 410 are configured to output discharge current through the first electrical path 420 to the bidirectional power converter 130. Additionally, the one or more battery cells 410 are configured to receive charging current through the first electrical path 420 from the bidirectional power converter 130.

In some instances, the battery 110 includes a first overcurrent protection device 425 and a second overcurrent protection device 430. Each of the overcurrent protection devices 425, 430 may include a fuse (e.g., a non-resettable fuse or a resettable fuse), a positive temperature coefficient (PTC) element, a circuit breaker, a burn track (e.g., an intentionally weak element) on a circuit board, and/or a solid-state device performing the same or a similar function as a fuse or the other elements listed above. As shown in FIG. 4, the second overcurrent protection device 430 may be electrically coupled in series with the first overcurrent protection device 425. A series combination of the first overcurrent protection device 425 and the second overcurrent protection device 430 may be electrically coupled between the one or more battery cells 410 and the bidirectional power converter 130 in one of the positive electrical path 415A and the negative electrical path 415B. In the example shown in FIG. 4, the series combination of the first overcurrent protection device 425 and the second overcurrent protection device 430 is included in the positive electrical path 415A. However, in other instances, the series combination of the first overcurrent protection device 425 and the second overcurrent protection device 430 is included in the negative electrical path 415B.

In some instances, the battery 110 may not include the second overcurrent protection device 430. In such instances, the first terminal of the switching element 435 may be electrically coupled between a junction between the first overcurrent protection device 425 and the bidirectional power converter 130.

In some instances, the battery 110 includes a switching element 435 that may include a first terminal electrically coupled between a junction 440 between the first overcurrent protection device 425 and the second overcurrent protection device 430. The switching element 435 may include a second terminal electrically coupled to the other one of the positive electrical path 415A and the negative electrical path 415B (i.e., opposite the one of the positive electrical path 415A and the negative electrical path 415B where the overcurrent protection devices 425, 430 are located). The switching element 435 may be an electronically controlled switch. For example, the switching element 435 may include a thyristor (e.g., a Silicon Controlled Rectifier (SCR), a TRIAC, or the like); a transistor such as a bipolar junction transistor (BJT) (e.g., Darlington type, a metal-oxide-semiconductor field-effect transistor (MOSFET), a junction field-effect transistor (JFET), or the like); a relay or contactor (e.g., of latching or non-latching type in any suitable contact arrangement); a thyratron; and/or the like. In the example shown in FIG. 4, the switching element 435 includes a SCR. In some instances, a third terminal (i.e., a control terminal) of the switching element 435 is coupled to a battery management system 445 of the battery 110. The switching element 435 may be coupled to the battery management system 445 via appropriate drive circuitry 450 (e.g., a driver, one or more resistors, and/or the like).

The battery management system 445 may include one or more circuit components (e.g., one or more integrated circuits) configured to provide the functionality described herein. In some instances, the battery management system 445 additionally or alternatively includes an electronic processor that is a part of or acts as the battery management system 445. The electronic processor may include a general purpose single- or multi-chip processor (e.g., a microprocessor, a microcontroller, an application specific integrated circuit (ASIC), a field programmable gate array (FPGA) or other programmable logic device, discrete gate or transistor logic, or discrete hardware components, or combinations thereof). The electronic processor may include or be coupled to a memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The electronic processor may include and/or may be electrically coupled to the memory and may execute software instructions that are capable of being stored in the memory. Software included in the implementation of the battery 110 can be stored in the memory. The software includes, for example, firmware, filters, rules, and/or other executable instructions. The electronic processor may be configured to retrieve from memory and execute, among other things, instructions related to the control processes and methods described herein.

In instances where an electronic processor is included in the battery management system 445, the electronic processor that performs the actions and/or methods described herein may include any one or a combination of electronic processors located within battery 110 or distributed among various devices and/or systems (e.g., the battery 110, the bidirectional power converter 130, etc.). Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

As shown in FIG. 4, the battery management system 445 may be communicatively coupled to the bidirectional power converter 130 via a communication connection 452 to send and/or receive control commands, status information, and/or the like. For example, control signals between the battery management system 445 of the battery 110 and the bidirectional power converter 130 may include dedicated electrical signals conveyed over a communication channel such as any one or a combination of RS232, RS485, a controller area network (CAN) bus, Ethernet, and the like. In some instances, the bidirectional power converter 130 may include its own electronic processor to communicate with the electronic processor of the battery management system 445. In some instances, control signals from the battery management system 445 may merely control switching elements (e.g., similar to switching element 435) of the bidirectional power converter 130, for example, to enable/disable operation of the bidirectional power converter 130.

In some instances, the battery 110 includes a plurality of sensors configured to monitor the one or more battery cells 410. The plurality of sensors is communicatively coupled to the battery management system 445 to allow the battery management system 445 to evaluate data monitored by the plurality of sensors. The plurality of sensors may include one or more of a current sensor(s) 455, a temperature sensor(s) 460, a voltage sensor(s) 465, and/or other types of sensors. In some instances, the current sensor 455 is configured to monitor the discharge current and the charging current. The current sensor 455 is shown in the negative electrical path 415B in FIG. 4. However, in other instances, the current sensor 455 may be located in the positive electrical path 415A. In some instances, the temperature sensor(s) 460 is configured to monitor at least one of a group consisting of a temperature of individual battery cells 410 of the one or more battery cells 410, a temperature of the battery 110, an ambient temperature of an environment in which the battery 110 is located, and combinations thereof. In some instances, the voltage sensor(s) 465 is configured to monitor a voltage of individual battery cells 410 of the one or more battery cells 410, an overall voltage of the one or more battery cells 410, or both the voltage of the individual battery cells 410 of the one or more battery cells and the overall voltage of the one or more battery cells 410.

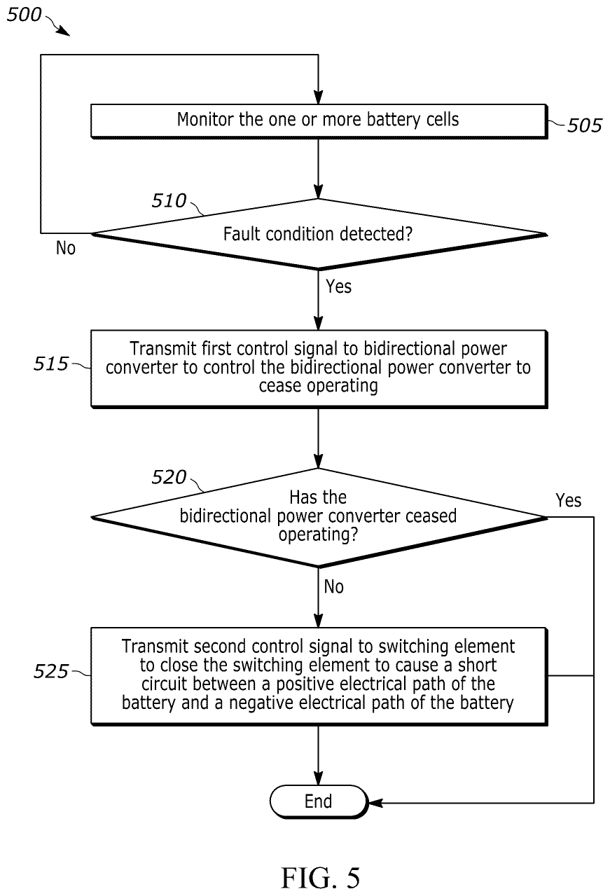

FIG. 5 illustrates a flowchart of a method 500 executable by the battery management system 445 of the battery 110 to provide fault protection to the battery 110 in response to a fault condition being detected according to some example embodiments. While a particular order of processing steps, control signal receptions, and/or control signal transmissions is indicated in FIG. 5 as an example, timing and ordering of such steps, receptions, and transmissions may vary where appropriate without negating the purpose and advantages of the examples set forth in detail throughout the remainder of this disclosure.

At block 505, the battery management system 445 monitors the one or more battery cells 410, for example, using at least one sensor of the plurality of sensors 455, 460, 465 described previously herein. Because the first electrical path 420 is the single electrical path for both charging and discharging of the one or more battery cells 410 via the bidirectional power converter 130, the battery management system 445 monitors the one or more battery cells 410 (at block 505) while the one or more battery cells are in the discharging state (i.e., while the one or more battery cells 410 are outputting discharge current through the first electrical path 420) and in the charging state (i.e., while the one or more battery cells 410 are receiving charging current through the first electrical path 420).

At block 510, the battery management system 445 determines whether a fault condition of the battery 110 has been detected. For example, a fault condition is detected by the battery management system 445 in response to one or more of the battery cells 410 being operated outside of a specified range (e.g., overtemperature, under-temperature, overvoltage, undervoltage, overcurrent, etc., and/or combinations thereof). When a fault condition is not detected (at block 510), the method 500 proceeds back to block 505 to repeat blocks 505 and 510 to monitor the one or more battery cells 410 for a fault condition. On the other hand, when a fault condition is detected (at block 510), the method 500 proceeds to block 515.

At block 515, the battery management system 445 transmits a first control signal to the bidirectional power converter 130 (via the communication connection 452) to control the bidirectional power converter 130 to cease operating in response to detecting the fault condition of the one or more battery cells 410. In many/most situations, the bidirectional power converter 130 will cease operating/shut down (i.e., prevent current flow through the bidirectional power converter 130 regardless of the direction in which current through the bidirectional power converter 130 is currently flowing) in response to the first control signal from the battery management system 445. However, in some instances, the bidirectional power converter 130 may remain active (i.e., continue to allow current flow) due to a failure/fault in the communication connection 452, the bidirectional power converter 130, and/or the battery 110. As a failsafe/backup shutdown method for such a situation, the battery management system 445 may take additional protective action in response to determining that the bidirectional power converter 130 has not ceased operating after the first control signal has been transmitted by the battery management system 445 as explained in greater detail below.

At block 520, the battery management system 445 determines whether the bidirectional power converter 130 has ceased operating (e.g., the bidirectional power converter 130 may have stopped operating in response to receiving the first control signal that was sent from the battery management system 445 at block 515). In some instances, the battery management system 445 waits a predetermined time period after transmitting the first control signal to the bidirectional power converter 130 before executing block 520. In some instances, the battery management system 445 determines that the bidirectional power converter 130 has not ceased operating within the predetermined time period by determining that a monitored value (e.g., current) from one of the sensors has not decreased at all or has not decreased by a predetermined amount. For example, the battery management system 445 determines that the bidirectional power converter 130 has not ceased operating based on the same or a similar current flowing through the current sensor at the time of execution of blocks 515 and 520. In some instances, the bidirectional power converter 130 is configured to respond to the first control signal with an acknowledgement signal or a non-acknowledgement signal. In response to not receiving the acknowledgement signal or receiving the non-acknowledgement signal, the battery management system 445 may determine that the bidirectional power converter 130 has not ceased operating. In instances in which the bidirectional power converter 130 is configured to send the acknowledgement signal or the non-acknowledgement signal, the battery management system 445 may not wait the predetermined time period or may wait a shorter predetermined period of time between blocks 515 and 520.

When the battery management system 445 determines that the bidirectional power converter 130 has ceased operating (at block 520) (e.g., operation ceased in response to receiving the first control signal from the battery management system 445), the method 500 ends and the battery 110 no longer provides current to or receives current from the bidirectional power converter 130 until the fault condition is inspected and the components of the battery 110 and the bidirectional power converter 130 are reset to clear the detection of the fault condition. As shown in FIG. 5, in such instances, block 525 is not executed by the battery management system 445. In other words, the battery management system 445 may be configured to refrain from transmitting a second control signal to the switching element 435 to close the switching element 435 to cause a short circuit between the positive electrical path 415A and the negative electrical path 415B (at block 525) in response to determining that the bidirectional power converter 130 has ceased operating (at block 520). In some instances, the battery management system 445 may automatically reset itself after a certain period of time of not detecting any fault conditions of the battery 110. In some instances, the battery management system 445 may automatically transmit another control signal to the bidirectional power converter 130 to allow the bidirectional power converter 130 to operate normally after a certain period of time of not detecting any fault conditions of the battery 110.

When the battery management system 445 determines that the bidirectional power converter 130 has not ceased operating (at block 520) even though the first control signal was transmitted, the method 500 proceeds to block 525. At block 525, the battery management system 445 transmits a second control signal to the switching element 435 to close the switching element 435 to cause a short circuit between the positive electrical path 415A and the negative electrical path 415B. In some instances, the battery management system 445 transmits the second control signal in response to determining that the bidirectional power converter 130 has not ceased operating (at block 520). In some instances, the short circuit between the positive electrical path 415A and the negative electrical path 415B causes at least the first overcurrent protection device 425 to open to prevent current from flowing into or out of the one or more battery cells 410.

For example, as shown in FIG. 4, the first overcurrent protection device 425 is electrically coupled between the one or more battery cells 410 and the second overcurrent protection device 430. Accordingly, the first overcurrent protection device 425 is located in the short circuit path between the positive electrical path 415A and the negative electrical path 415B when the switching element 435 is closed to cause the short circuit between the positive electrical path 415A and the negative electrical path 415B. The short circuit path between the positive electrical path 415A and the negative electrical path 415B of the battery 110 causes the one or more battery cells to briefly (e.g., almost instantaneously) discharge a high current that causes the first overcurrent protection device 425 to open. The first overcurrent protection device 425 opens in response to current from the one or more battery cells 410 through the short circuit exceeding a current limit of the first overcurrent protection device 425. Once the first overcurrent protection device 425 is opened, current is prevented from flowing into or out of the one or more battery cells 410, for example, to or from the bidirectional power converter 130. Accordingly, the switching element 435 and the first overcurrent protection device 425 form a protective circuit (e.g., a crowbar circuit) that acts as a failsafe to prevent current from flowing into or out of the one or more battery cells 410 in the event that the bidirectional power converter 130 continues operating after the battery management system 445 instructs the bidirectional power converter 130 to cease operating (at block 515). The crowbar circuit may be activated (i.e., the switching element 435 may be controlled to close to cause a short circuit) while the battery 110 is charging or while the battery 110 is discharging. Activation of the crowbar circuit may remove the fault condition or at least prevent the fault condition from increasing in severity.

As shown in FIG. 4, in some instances, the second overcurrent protection device 430 is electrically coupled between the first overcurrent protection device 425 and the bidirectional power converter 130. In some instances, the short circuit between the positive electrical path 415A and the negative electrical path 415B causes the second overcurrent protection device 430 to open in response to current from the bidirectional power converter 130 through the short circuit exceeding a current limit of the second overcurrent protection device 430. For example, if the bidirectional power converter 130 is delivering a high enough amount of current when the switching element 435 is closed (i.e., when the crowbar circuit is activated), the second overcurrent protection device 430 will open. In some instances, a current limit of the first overcurrent protection device 425 may be the same or different than the current limit of the second overcurrent protection device 430. In some instances, opening of the second overcurrent protection device 430 prevents current draw by the battery 110 from the bidirectional power converter 130. For example, the second overcurrent protection device 430 is configured to prevent the switching element 435, when closed, from causing a short circuit of long duration and high current draw on the DC side of the bidirectional power converter 130, which prevents a potential hazard/fault condition (e.g., overcurrent, overtemperature, etc.) involving the bidirectional power converter 130.

Referring back to FIG. 5, when the battery management system 445 performs block 525 to cause the short circuit between the positive electrical path 415A and the negative electrical path 415B of the battery 110, the method 500 ends and the battery 110 no longer provides current to or receives current the bidirectional power converter 130 until the fault condition is inspected and the components of the battery 110 are reset to clear the detection of the fault detection. In some instances, after a certain period of time of not detecting any fault conditions of the battery 110, the battery management system 445 may automatically reset itself (e.g., open the switching element 435 to re-allow normal battery operation) and the overcurrent protection devices 425, 430 (e.g., PTC elements) may automatically reset themselves.

With reference to FIG. 5, fault conditions may be detected (at block 510) in any one or combination of different manners. Additionally, a severity of fault conditions may be determined (at block 510 and/or thereafter) such that, in some instances, the battery management system 445 operates differently depending on the severity of one or more fault conditions.

In some instances, the battery management system 445 detects a fault condition by comparing a monitored value from one of the sensors to a threshold value (e.g., an overcurrent limit, an overvoltage limit, an undervoltage limit, an overtemperature limit, an under-temperature limit, and/or the like). In response to the monitored value crossing the threshold value, the battery management system 445 may detect a fault condition. In some instances, the battery management system 445 detects a fault condition in response to numerous monitored values of different sensors exceeding a respective threshold value.

In some instances, the battery management system 445 determines a severity of the fault condition based on an amount of monitored characteristics that have exceeded their respective threshold values (e.g., a larger amount of monitored characteristics outside of their desired operating range may indicate a more severe fault condition than a lesser amount of monitored characteristics outside of their desired operating range). Additionally or alternatively, the battery management system 445 may determine a severity of the fault condition based on a difference between an amount of a monitored value that has crossed the threshold value and the threshold value itself. For example, a monitored value (e.g., current) that has exceeded an overcurrent limit by a large amount may indicate a more severe fault condition than a monitored value (e.g., current) that has exceeded the overcurrent limit by a lesser amount.

In some instances (e.g., when the fault condition is determined to be severe or for certain applications regardless of the severity of the fault condition), the battery management system 445 may bypass block 520 of the method 500 and may simultaneously perform blocks 515 and 525 in response to detecting the severe fault condition (or any fault condition). In other words, in some instances, block 520 may not be included in the method 500.

In some instances, the predetermined time period that the battery management system 445 may wait after performing block 515 may be adjusted or interrupted depending on a severity of the fault condition detected. For example, the battery management system 445 may transmit the first control signal to the bidirectional power converter 130 to control the bidirectional power converter 130 to cease operating (at block 515) in response to detecting a first fault condition. Continuing this example, the battery management system 445 may determine, before the predetermined time period has elapsed, that (i) the fault condition has worsened (e.g., crossed a second threshold value that is higher than a first threshold value that initially triggered detection of the fault condition), (ii) a second fault condition has been detected, or (iii) both (i) and (ii). Additionally, the battery management system 445 may transmit, before the predetermined time period has elapsed, the second control signal to the switching element 435 to close the switching element 435 to cause the short circuit between the positive electrical path 415A and the negative electrical path 415B (at block 525) in response to determining that (i) the fault condition has worsened (e.g., crossed a second threshold value that is higher than a first threshold value that initially triggered detection of the fault condition), (ii) the second fault condition has been detected, or (iii) both (i) and (ii). As another example, the battery management system 445 may determine the predetermined time period to wait between blocks 515 and 520 based on a type of the fault condition and/or a severity of the fault condition. For example, the battery management system 445 may wait a shorter predetermined period of time between blocks 515 and 520 when an overcurrent fault condition is detected than when an undervoltage fault condition is detected. As another example, the battery management system 445 may wait a shorter period of time when a more severe fault condition is detected (e.g., overvoltage above the overvoltage threshold by a greater amount or above a second higher overvoltage threshold) than when a less severe fault condition is detected (e.g., overvoltage above the overvoltage threshold by a lesser amount or only above a first lower overvoltage threshold).

Referring back to FIGS. 2A-2C, the battery 110, 210, 240 may include a housing (e.g., the housing 205 of the portable power source 100A, a housing of a power tool battery pack, etc.) configured to house the one or more battery cells 410, the first overcurrent protection device 425, the second overcurrent protection device 430, the switching element 435, and/or the battery management system 445. The housing of the battery 110, 210, 240 includes at least one of a group consisting of (i) a removable battery pack housing configured to be removably coupled to a power tool device 110C, (ii) a portable power source housing 205, (iii) a power tool device housing 255, and (iv) combinations thereof.

Although the disclosure has been described in detail with reference to certain preferred embodiments, variations and modifications exist within the scope and spirit of one or more independent aspects of the disclosure as described. Various features and advantages are set forth in the following claims.

What is claimed is:

1. A battery comprising:
one or more battery cells electrically coupled to a bidirectional power converter via a positive terminal and a negative terminal, wherein the one or more battery cells are configured to:
output discharge current through a first electrical path between the one or more battery cells and the bidirectional power converter, wherein the first electrical path includes (i) a positive electrical path between the one or more battery cells and the positive terminal and (ii) a negative electrical path between the one or more battery cells and the negative terminal, and
receive charging current through the first electrical path from the bidirectional power converter;
a first overcurrent protection device;
a second overcurrent protection device electrically coupled in series with the first overcurrent protection device, wherein a series combination of the first overcurrent protection device and the second overcurrent protection device is electrically coupled between the one or more battery cells and the bidirectional power converter in one of the positive electrical path and the negative electrical path;
a switching element including:
a first terminal electrically coupled between a junction between the first overcurrent protection device and the second overcurrent protection device, and
a second terminal electrically coupled to the other one of the positive electrical path and the negative electrical path; and
a battery management system communicatively coupled to the switching element, wherein the battery management system is configured to:
monitor the one or more battery cells,
detect a fault condition of the one or more battery cells,
transmit a first control signal to the bidirectional power converter to control the bidirectional power converter to cease operating in response to detecting the fault condition of the one or more battery cells, and
transmit a second control signal to the switching element to close the switching element to cause a short circuit between the positive electrical path and the negative electrical path, wherein the short circuit between the positive electrical path and the negative electrical path causes at least the first overcurrent protection device to open to prevent current from flowing into or out of the one or more battery cells.

2. The battery of claim 1, wherein the first overcurrent protection device is electrically coupled between the one or more battery cells and the second overcurrent protection device, and wherein the second overcurrent protection device is electrically coupled between the first overcurrent protection device and the bidirectional power converter;
wherein the short circuit between the positive electrical path and the negative electrical path causes the second overcurrent protection device to open in response to current from the bidirectional power converter through the short circuit exceeding a current limit of the second overcurrent protection device; and
wherein opening of the second overcurrent protection device prevents current draw from the bidirectional power converter.

3. The battery of claim 1, wherein the first overcurrent protection device is electrically coupled between the one or more battery cells and the second overcurrent protection device, and wherein the second overcurrent protection device is electrically coupled between the first overcurrent protection device and the bidirectional power converter;
wherein the first overcurrent protection device opens in response to current from the one or more battery cells through the short circuit exceeding a current limit of the first overcurrent protection device.

4. The battery of claim 1, wherein the battery management system is configured to:
wait a predetermined time period after transmitting the first control signal to the bidirectional power converter;
determine that the bidirectional power converter has not ceased operating within the predetermined time period; and
transmit the second control signal to the switching element to close the switching element to cause the short circuit between the positive electrical path and the negative electrical path in response to determining that the bidirectional power converter has not ceased operating.

5. The battery of claim 4, wherein the battery management system is configured to:
determine, before the predetermined time period has elapsed, that (i) the fault condition has worsened, (ii) a second fault condition has been detected, or (iii) both (i) and (ii); and
transmit, before the predetermined time period has elapsed, the second control signal to the switching element to close the switching element to cause the short circuit between the positive electrical path and the negative electrical path in response to determining that (i) the fault condition has worsened, (ii) the second fault condition has been detected, or (iii) both (i) and (ii).

6. The battery of claim 1, wherein the battery management system is configured to:
wait a predetermined time period after transmitting the first control signal to the bidirectional power converter;
determine that the bidirectional power converter has ceased operating within the predetermined time period; and
refrain from transmitting the second control signal to the switching element to close the switching element to cause the short circuit between the positive electrical path and the negative electrical path in response to determining that the bidirectional power converter has ceased operating.

7. A battery comprising:
one or more battery cells electrically coupled to a bidirectional power converter, wherein the one or more battery cells are configured to:
output discharge current through a first electrical path between the one or more battery cells and the bidirectional power converter, and
receive charging current through the first electrical path from the bidirectional power converter;
a first overcurrent protection device electrically coupled between the one or more battery cells and the bidirectional power converter, wherein the first overcurrent protection device is electrically coupled to one of a positive side and a negative side of the battery;
a switching element including:
a first terminal electrically coupled between a junction between the first overcurrent protection device and the bidirectional power converter, and
a second terminal electrically coupled to the other one of the positive side and the negative side of the battery; and
a battery management system communicatively coupled to the switching element, wherein the battery management system is configured to:
monitor the one or more battery cells,
detect a fault condition of the one or more battery cells,
transmit a first control signal to the bidirectional power converter to control the bidirectional power converter to cease operating in response to detecting the fault condition of the one or more battery cells, and
transmit a second control signal to the switching element to close the switching element to cause a short circuit between the positive side and the negative side of the battery, wherein the short circuit between the positive side and the negative side causes the first overcurrent protection device to open to prevent current from flowing into or out of the one or more battery cells.

8. The battery of claim 7, further comprising a second overcurrent protection device electrically coupled in series with the first overcurrent protection device, wherein a series combination of the first overcurrent protection device and the second overcurrent protection device is electrically coupled between the one or more battery cells and the bidirectional power converter on the one of the positive side and the negative side of the battery;
wherein the first overcurrent protection device is electrically coupled between the one or more battery cells and the second overcurrent protection device, and wherein the second overcurrent protection device is electrically coupled between the first overcurrent protection device and the bidirectional power converter;
wherein the junction is located between the first overcurrent protection device and the second overcurrent protection device;
wherein the short circuit between the positive side and the negative side causes the second overcurrent protection device to open in response to current from the bidirectional power converter through the short circuit exceeding a second current limit of the second overcurrent protection device;
wherein opening of the second overcurrent protection device prevents current draw from the bidirectional power converter; and
wherein the first overcurrent protection device opens in response to current from the one or more battery cells through the short circuit exceeding a first current limit of the first overcurrent protection device.

9. The battery of claim 7, wherein the battery management system is configured to:
wait a predetermined time period after transmitting the first control signal to the bidirectional power converter;
determine that the bidirectional power converter has not ceased operating within the predetermined time period; and
transmit the second control signal to the switching element to close the switching element to cause the short circuit between the positive side and the negative side in response to determining that the bidirectional power converter has not ceased operating.

10. The battery of claim 9, wherein the battery management system is configured to:
determine, before the predetermined time period has elapsed, that (i) the fault condition has worsened, (ii) a second fault condition has been detected, or (iii) both (i) and (ii); and
transmit, before the predetermined time period has elapsed, the second control signal to the switching element to close the switching element to cause the short circuit between the positive side and the negative side in response to determining that (i) the fault condition has worsened, (ii) the second fault condition has been detected, or (iii) both (i) and (ii).

11. The battery of claim 7, wherein the battery management system is configured to:
determine that the bidirectional power converter has ceased operating; and
refrain from transmitting the second control signal to the switching element to close the switching element to cause the short circuit between the positive side and the negative side in response to determining that the bidirectional power converter has ceased operating.

12. The battery of claim 7, further comprising a plurality of sensors configured to monitor the one or more battery cells, wherein the plurality of sensors is communicatively coupled to the battery management system, and wherein the plurality of sensors include at least one of a group consisting of:
a current sensor configured to monitor the discharge current and the charging current;
a temperature sensor configured to monitor at least one of a group consisting of a temperature of individual battery cells of the one or more battery cells, a temperature of the battery, an ambient temperature of an environment in which the battery is located, and combinations thereof;
a voltage sensor configured to monitor a voltage of individual battery cells of the one or more battery cells, an overall voltage of the one or more battery cells, or both the voltage of individual battery cells of the one or more battery cells and the overall voltage of the one or more battery cells; and
combinations thereof.

13. The battery of claim 7, wherein the first overcurrent protection device includes one of a fuse, a positive temperature coefficient (PTC) element, a circuit breaker, and a burn track; and
wherein the switching element includes one of a thyristor, a transistor, a relay, a contactor, and a thyratron.

14. The battery of claim 7, further comprising a housing configured to house the one or more battery cells, the first overcurrent protection device, the switching element, and the battery management system;
wherein the housing includes at least one of a group consisting of (i) a removable battery pack housing configured to be removably coupled to a power tool device, (ii) a portable power source housing, (iii) a power tool device housing, and (iv) combinations thereof.

15. A method of controlling a battery, the method comprising:
outputting, by one or more battery cells of the battery in a discharging state, discharge current through a first electrical path between the one or more battery cells and a bidirectional power converter;
receiving, by the one or more battery cells in a charging state, charging current through the first electrical path;
monitoring, with a battery management system of the battery, the one or more battery cells of the battery while the one or more battery cells are in the discharging state and while the one or more battery cells are in the charging state;
detecting, with the battery management system, a fault condition of the one or more battery cells;
transmitting, with the battery management system, a first control signal to the bidirectional power converter to control the bidirectional power converter to cease operating in response to detecting the fault condition of the one or more battery cells; and
transmitting, with the battery management system, a second control signal to a switching element to close the switching element to cause a short circuit between a positive side and a negative side of the battery, wherein the short circuit between the positive side and the negative side causes a first overcurrent protection device to open to prevent current from flowing into or out of the one or more battery cells.

16. The method of claim 15, wherein the short circuit between the positive side and the negative side causes a second overcurrent protection device to open to prevent current draw from the bidirectional power converter;
wherein the second overcurrent protection device is electrically coupled in series with the first overcurrent protection device, and wherein a series combination of the first overcurrent protection device and the second overcurrent protection device is electrically coupled between the one or more battery cells and the bidirectional power converter on one of the positive side and the negative side of the battery;
wherein the first overcurrent protection device is electrically coupled between the one or more battery cells and the second overcurrent protection device, and wherein the second overcurrent protection device is electrically coupled between the first overcurrent protection device and the bidirectional power converter;
wherein the short circuit between the positive side and the negative side causes the second overcurrent protection device to open in response to current from the bidirectional power converter through the short circuit exceeding a second current limit of the second overcurrent protection device; and
wherein the first overcurrent protection device opens in response to current from the one or more battery cells through the short circuit exceeding a first current limit of the first overcurrent protection device.

17. The method of claim 15, further comprising:
waiting, with the battery management system, a predetermined time period after transmitting the first control signal to the bidirectional power converter;
determining, with the battery management system, that the bidirectional power converter has not ceased operating within the predetermined time period; and
transmitting, with the battery management system, the second control signal to the switching element to close the switching element to cause the short circuit between the positive side and the negative side in response to determining that the bidirectional power converter has not ceased operating.

18. The method of claim 17, further comprising:
determining, with the battery management system and before the predetermined time period has elapsed, that (i) the fault condition has worsened, (ii) a second fault condition has been detected, or (iii) both (i) and (ii); and
transmitting, with the battery management system and before the predetermined time period has elapsed, the second control signal to the switching element to close the switching element to cause the short circuit between the positive side and the negative side in response to determining that (i) the fault condition has worsened, (ii) the second fault condition has been detected, or (iii) both (i) and (ii).

19. The method of claim 15, further comprising:
determining, with the battery management system, that the bidirectional power converter has ceased operating; and
refraining, with the battery management system, from transmitting the second control signal to the switching element to close the switching element to cause the short circuit between the positive side and the negative side in response to determining that the bidirectional power converter has ceased operating.

20. The method of claim 15, wherein monitoring the one or more battery cells includes monitoring, with a plurality of sensors, the one or more battery cells, wherein the plurality of sensors are communicatively coupled to the battery management system, and wherein the plurality of sensors include at least one of a group consisting of:
a current sensor configured to monitor the discharge current and the charging current;
a temperature sensor configured to monitor at least one of a group consisting of a temperature of individual battery cells of the one or more battery cells, a temperature of the battery, an ambient temperature of an environment in which the battery is located, and combinations thereof;
a voltage sensor configured to monitor a voltage of individual battery cells of the one or more battery cells, an overall voltage of the one or more battery cells, or both the voltage of individual battery cells of the one or more battery cells and the overall voltage of the one or more battery cells; and
combinations thereof.
